(19) United States
(12) Patent Application Publication
(10) Pub. No.: US 2004/0201794 A1
(43) Pub. Date: Oct. 14, 2004

(54) Liquid crystal display and backlight module thereof

(76) Inventors: Ga-Lane Chen, Fremont, CA (US); Tai-Cherng Yu, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/788,577

(22) Filed: Feb. 27, 2004

(30) Foreign Application Priority Data
Feb. 27, 2003 (TW) 92203130

(51) Int. Cl. G02F 1/1335

(52) U.S. Cl. 349/65; 349/113

(57) ABSTRACT

A liquid crystal display (3) in accordance with one embodiment of the present invention includes a liquid crystal panel and a backlight module (36). The liquid crystal panel has a reflective polarizing element (342). The backlight module has a light source (361), a light guide plate (362), a reflector (365), and a quarter-wave plate (366). The light source is disposed adjacent to one side of the light guide plate, and the reflector, the quarter-wave plate and the light guide plate are stacked together from bottom to top in that order. The liquid crystal panel is located on the backlight module, and the reflective polarizing element of the liquid crystal panel faces the light guide plate. The liquid crystal display has a high brightness since light energy is efficiently used.

### BACKGROUND OF THE INVENTION

1. Field of the Invention

The present invention relates to a liquid crystal display and a backlight module thereof, and particularly to a liquid crystal display and a backlight module thereof with high brightness.

2. Description of Prior Art

Conventional backlight modules for use in rear projection displays such as liquid crystal displays are classified into two types, an edge-type and a direct type, depending upon the position of the light sources in the displays. Edge-type backlight modules are usually used in liquid crystal displays because they save space due to their thinness.

A conventional liquid crystal display has a structure shown in FIG. 5. The liquid crystal display 1 includes a backlight module 16 and a liquid crystal panel (not labeled). The liquid crystal panel is disposed on the backlight module 16.

The liquid crystal panel comprises a first substrate 10, a second substrate 14, and a liquid crystal layer 12 interposed therebetween. The first substrate 10 includes a first glass sheet 101 and a light polarizing film 102. The second substrate 14 includes a second glass sheet 141 and a light polarizing absorption film 142. The backlight module 16 comprises a light source 161, a light guide plate 162, a brightness enhancing film 163, a diffuser 164, and a reflector 165.

FIG. 6 is a partially essential optical paths view of the liquid crystal display 1 in FIG. 5. Light beams emitted from the light source 161 are converted to planar light beams T when they are emitted out from the backlight module 16, and then are projected into the light polarizing absorption film 142. The planar light beams T are randomly polarized into two linear polarized light beams, an s-polarization component and a p-polarization component (denoted by arrows s and p shown in FIG. 6). The polarization state of the s-polarization component is orthogonal to that of the p-polarization component. The light polarizing absorption film 142 has a polarization axis parallel to the s-polarization component, so that the s-polarization component of the planar light beams T can pass. The light polarizing absorption film 142 also has an absorption axis parallel to the p-polarization component, so that the p-polarization component of the planar light beams is absorbed. Therefore, only half of the light beams T can pass through the light polarizing absorption film 142. The light energy of the light beams T is not effectively used due to the light polarizing absorption film 142 absorbs half of the light beams T, and the brightness of the liquid crystal display 1 is low.

To solve the above problems, a liquid crystal display 2 shown in FIG. 7 is described in U.S. Pat. No. 6,448,955. The liquid crystal display 2 comprises a liquid crystal panel (not labeled) and a backlight module 26. The liquid crystal panel is disposed on the backlight module 26.

The liquid crystal panel is similar to that shown in FIG. 5 and includes a first substrate 20, a second substrate 24, and a liquid crystal layer 22 interposed therebetween. A light polarizing film (not labeled) is attached to an outer surface of the second substrate 24, and the outer surface faces the backlight module 26. The backlight module 26 consists of two light sources 2611, 2612, two light guide plates 2621, 2622, a brightness enhancing film 263, a diffuser 264, a reflector 265, and a reflective polarizing element 266. The light sources 2611 and 2612 are disposed adjacent to one side of the light guide plates 2621, 2622, respectively. The reflector 265, the light guide plates 2622, 2621, the diffuser 264, the brightness enhancing film 263, and the reflective polarizing element 266 are stacked together from bottom to top in that order.

FIG. 8 is a partially essential light paths view in FIG. 7. Light beams T are randomly polarized, and consist of two linear polarized light beams, an s-polarization component and a p-polarization component (denoted by arrows s and p shown in FIG. 8). The polarization state of the s-polarization component is orthogonal to that of the p-polarization component. The reflective polarizing element 266 has a polarization axis parallel to the s-polarization component, so that the s-polarization component of the light beams T can pass through the reflective polarizing element 266. The reflective polarizing element 266 also has a reflection axis parallel to the p-polarization component, so the p-polarization component is reflected to the reflector 265. The reflected p-polarization component is partially converted to an s-polarization component, which then passes through the reflective polarizing element 266. The structure described above, can reuse the reflected p-polarization component, and increases the brightness of the liquid crystal display 2.

Although the liquid crystal display 2 can reuse the reflected p-polarization component, the efficiency is poor because the liquid crystal display 2 needs both a reflective polarizing element 266 and the light polarizing film, and has a plurality of optical interfaces. The various optical interfaces cumulatively contribute to an unduly high loss of light intensity in the backlight module 26. These liquid crystal displays (1, 2) all lack a special optical element to efficiently convert the reflected p-polarization component to an s-polarization component, so that these liquid crystal displays can't efficiently utilize light energy.

An improved liquid crystal display that overcomes the above-mentioned disadvantages is desired.

### SUMMARY OF THE INVENTION

An object of the present invention is to provide a liquid crystal display having a high brightness, and which efficiently utilizes light energy.

In order to achieve the object set forth, a liquid crystal display in accordance with one embodiment of the present invention comprises a liquid crystal panel and a backlight module, the liquid crystal panel has a reflective polarizing element, and the backlight module has a light source, a light guide plate, a reflector, and a quarter-wave plate. The light source is disposed adjacent to the light guide plate, and the reflector, the quarter-wave plate and the light guide plate are stacked together in order. The liquid crystal panel is located on the backlight module, and the reflective polarizing element of the liquid crystal panel faces toward the light guide plate.

Other objects, advantages and novel features of the invention will become more apparent from the following detailed description when taken in conjunction with the accompanying drawings.

### BRIEF DESCRIPTION OF THE DRAWINGS

FIG. 1 is a schematic view of a first embodiment of a liquid crystal display according to the present invention;

FIG. 2 is a partially essential light paths view of the liquid crystal display in FIG. 1;

FIG. 3 is a schematic view of a second embodiment of a liquid crystal display according to the present invention;

FIG. 4 is a schematic view of a third embodiment of a liquid crystal display according to the present invention;

FIG. 5 is a schematic view of a conventional liquid crystal display;

FIG. 6 is a partially essential light paths view of the liquid crystal display in FIG. 5;

FIG. 7 is a schematic view of another conventional liquid crystal display;

FIG. 8 is a partially essential light paths view of the liquid crystal display in FIG. 7;

### DESCRIPTION OF THE PREFERRED EMBODIMENT(S)

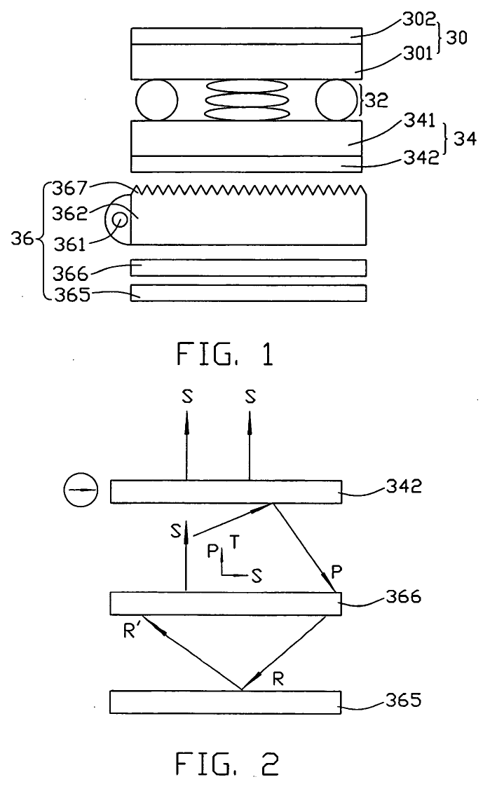

FIG. 1 is a schematic view of a first embodiment of a liquid crystal display according to the present invention. The liquid crystal display 3 comprises a liquid crystal panel (not labeled) and a backlight module 36. The liquid crystal panel is disposed on the backlight module 36.

The liquid crystal panel comprises a first substrate 30, a second substrates 34, and a liquid crystal layer 32 interposed therebetween. The first substrate 30 includes a first glass sheet 301 and a light polarizing film 302, and the second substrate 34 includes a second glass sheet 341 and a reflective polarizing element 342.

The backlight module 36 includes a light source 361, a light guide plate 362, a reflector 365, and a quarter-wave plate 366. The reflector 365, the quarter-wave plate 366, and the light guide plate 362 are stacked from bottom to top in that order. The light source 361 is disposed adjacent to the light guide plate 362. A plurality of V-shaped grooves 367 is defined on a top surface of the light guide plate 362, and the top surface faces the reflective polarizing element 342.

FIG. 2 is a partial essential light paths view of the liquid crystal display in FIG. 1. After passing through the light guide plate 362, Light beams emitted from the light source 361 are randomly polarized into planar light beams T which is decomposed of an s-polarization component and a p-polarization component (denoted by arrows s and p). The s-polarization component is orthogonal to the p-polarization component. The reflective polarizing element 342 of the liquid crystal panel has a polarization axis parallel to the s-polarization component, so that the s-polarization component can pass. The reflective polarizing element 342 also has a reflection axis parallel to the p-polarization component, so that the p-polarization component is reflected to the quarter-wave plate 366.

The quarter-wave plate 366 is an optical element made of mica, polyvinyl alcohol, or other components, which introduces a relative phase shift of Δφ=π/2 between the constituent orthogonal p-polarization component and s-polarization component of a wave. A phase shift of π/2 will convert linear light to circular light when linear light at 45° to either principal axis is incident on the quarter-wave plate 366, and vice versa. Linear light incident parallel to either principal axis will be unaffected by the quarter-wave plate. Excluding these special circumstances, linear light will be converted to an elliptical light. Therefore, the reflected p-polarization component is converted to a first polarization component R, when it passes through the quarter-wave plate 366 a first time. The first polarization component R is converted in to a second polarization component R′ after being reflected by the reflector 365. The first polarization component R and the second polarization component R′ are linear, circular or elliptical polarization component, depending on the incident angle of the reflected p-polarization component. Then, the second polarization component R′ is partially or all converted to a linear polarization component when it passes the quarter-wave plate 366. The linear polarization component has a polarization state orthogonal to the reflected p-polarization component, i.e., the reflected p-polarization component is converted to an s-polarization component after passing the quarter-wave plate 366 twice.

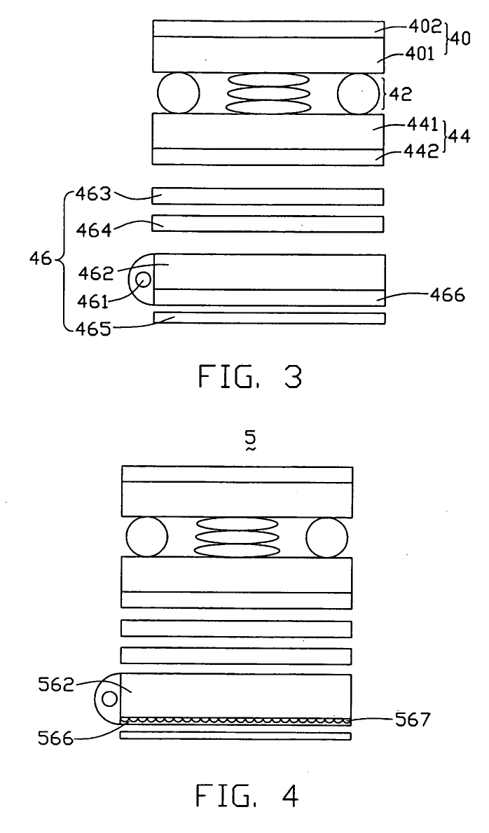

FIG. 3 illustrates a schematic view of a second embodiment of a liquid crystal display 4 according to the present invention. The liquid crystal display 4 comprises a liquid crystal panel (not labeled) and a backlight module 46. The liquid crystal panel is disposed on the backlight module 46.

The liquid crystal panel comprises a first substrate 40, a second substrate 44, and a liquid crystal layer 42 interposed therebetween. The first substrate 40 includes a first glass sheet 401 and a light polarizing film 402, and the second substrate 44 includes a second glass sheet 441 and a reflective polarizing element 442.

The backlight module 46 includes a light source 461, a light guide plate 462, a reflector 465, a quarter-wave plate 466, a brightness enhancing film 463, and a diffuser 464. The reflector 465, the quarter-wave plate 466, the light guide plate 462, the diffuser 464 and the brightness enhancing film 463 are stacked from bottom to top in that order. The light source 461 is disposed adjacent to one side of the light guide plate 462. The quarter-wave plate 466 is attached to a bottom surface (not labeled) of the light guide plate 462 by means of glue, for example, to decrease the thickness of the liquid crystal display 4.

FIG. 4 illustrates a schematic view of a third embodiment of a liquid crystal display 5 according to the present invention. Compared with the backlight module 46 in FIG. 3, a plurality of printing-dots 567 is defined on a bottom surface (not labeled) of a light guide plate 562 in order to increase the uniformity of light beams emitted from the backlight module. A quarter-wave plate 566 is attached to the printing-dots 567 by means of, for example, glue.

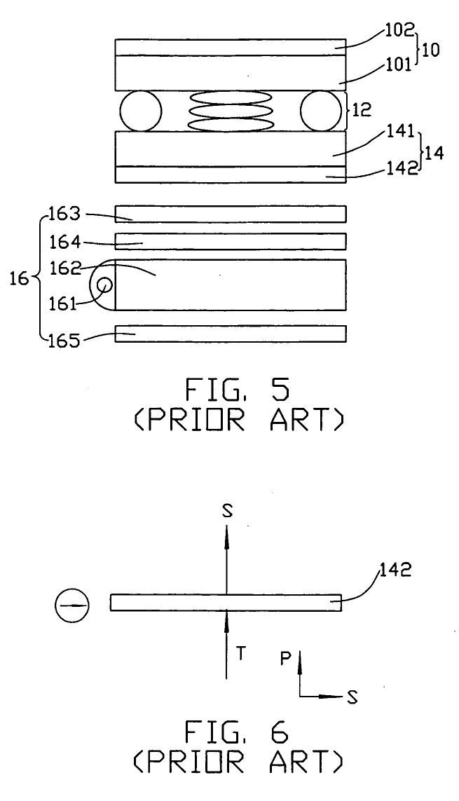

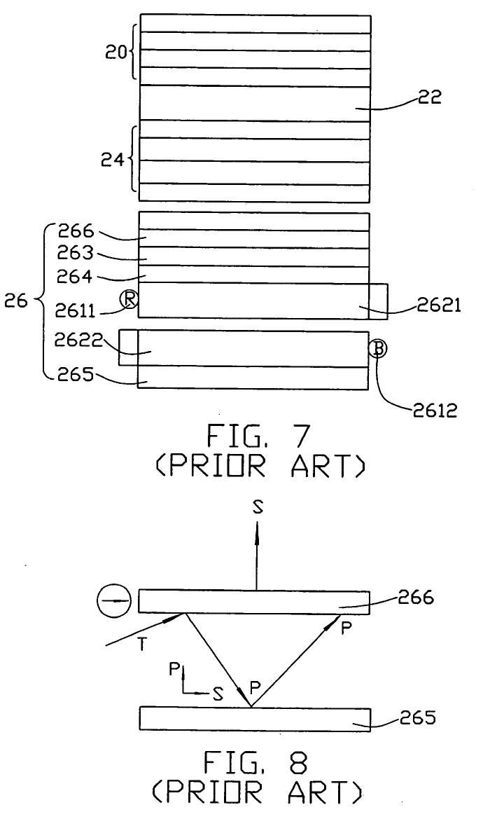

By utilization of the quarter-wave plate and the reflective polarizing element, the above-mentioned liquid crystal displays efficiently convert the reflected p-polarization component to the s-polarization component, and efficiently utilizes light energy. Therefore, the liquid crystal displays has a higher brightness than those conventional liquid crystal displays shown in FIGS. 5 and 7.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A liquid crystal display, comprising:
a backlight module having a light source, a light guide plate, a reflector, and a quarter-wave plate, the light source being disposed adjacent to one side of the light guide plate, and the reflector, the quarter-wave plate and the light guide plate being stacked together from bottom to top in that order; and
a liquid crystal panel having a reflective polarizing element, the liquid crystal panel is located on the backlight module, and the reflective polarizing element faces a top surface of the light guide plate.

2. The liquid crystal display of claim 1, wherein a plurality of V-shaped grooves is defined on the top surface of the light guide plate.

3. The liquid crystal display of claim 1, wherein the quarter-wave plate is attached to a bottom surface of the light guide plate.

4. The liquid crystal display of claim 3, further comprising a diffuser disposed between the liquid crystal panel and the light guide plate.

5. The liquid crystal display of claim 4, further comprising a brightness enhancing film disposed between the diffuser and the liquid crystal panel.

6. The liquid crystal display of claim 5, further comprising a plurality of printing-dots being defined on the bottom surface.

7. A backlight module, comprising:
a reflector, a quarter-wave plate and a light guide plate being stacked together from bottom to top in that order; and
a light source, being disposed adjacent to one side of the light guide plate.

8. The liquid crystal display of claim 7, wherein a plurality of V-shaped grooves is defined on a top surface of the light guide plate.

9. The liquid crystal display of claim 7, wherein the quarter-wave plate is attached to a bottom surface of the light guide plate.

10. The liquid crystal display of claim 9, further comprising a diffuser disposed between the liquid crystal panel and the light guide plate.

11. The liquid crystal display of claim 10, further comprising a brightness enhancing film disposed between the diffuser and the liquid crystal panel.

12. The liquid crystal display of claim 11, further comprising a plurality of printing-dots being defined on the bottom surface.

13. A liquid crystal display comprising:
a light guide plate;
a light source located by one side of the light guide plate;
a quarter-wave plate located under said light guide plate;
a reflector located under said quarter-wave plate; and
a reflective polarizing element located above the light guide plate.
